(19) United States
(12) Patent Application Publication
(10) Pub. No.: US 2022/0385408 A1
(43) Pub. Date: Dec. 1, 2022

(54) METHOD AND DEVICE FOR SIDELINK WIRELESS COMMUNICATION

(71) Applicants: Jinfang ZHANG, SHANGHAI (CN); Xiaobo ZHANG, SHANGHAI (CN)

(72) Inventors: Jinfang ZHANG, SHANGHAI (CN); Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 17/751,707

(22) Filed: May 24, 2022

(30) Foreign Application Priority Data
May 27, 2021 (CN) 202110585225.8

(51) Int. Cl. H04L 1/18; H04W 24/02; H04W 76/28

(52) U.S. Cl. CPC H04L 1/188; H04W 24/02; H04W 76/28

(57) ABSTRACT

The present disclosure provides a method and device for sidelink wireless communications. A first node transmits a first signaling and a first radio signal; monitors a second signaling; maintains a first counter according to whether the second signaling is received; and as a response to a value of the first counter reaching a first threshold, determines an RLF for a second node; the behavior of maintaining a first counter according to whether the second signaling is received comprises: when the second signaling is received, updating the value of the first counter to an initial value; when the second signaling is not received and a time for transmitting the first signaling belongs to an active estimation time, updates the value of the first counter by 1. The application reduces the risk of triggering unnecessary Radio Link Failure (RLF).

### CROSS REFERENCE TO RELATED APPLICATIONS

This application claims the priority benefit of Chinese Patent Application No. 202110585225.8, filed on May 27,2021, the full disclosure of which is incorporated herein by reference.

### BACKGROUND

### Technical Field

The present disclosure relates to methods and devices in wireless communication systems, and in particular to a method and a device for triggering Radio Link Failure (RLF) when Discontinuous Reception (DRX) is supported in sidelink wireless communications.

### Related Art

Discontinuous Reception (DRX) is a common method in cellular communications to reduce the power consumption of communication terminals and improve the standby time. A base station controls a DRX-related timer through Downlink Control Information (DCI) or a Medium Access Control (MAC) Control Element (CE), then controls whether the terminal is in active time at a given time slot or subframe, so as to control wireless reception of the communication terminal, including that when the terminal is in active time, the terminal monitors and receives a radio signal, and when the terminal is in inactive time, the terminal stops monitoring a radio signal.

Radio link failure (RLF) is also a common method in cellular networks. A User Equipment (UE) monitors downlink radio link quality and triggers an RLF when a continuous low radio link quality is detected, which is used to recover a radio connection with a base station.

Application scenarios of future wireless communication systems are becoming increasingly diversified, and different application scenarios have different performance demands on systems. To meet these various performance requirements, 3rd Generation Partner Project (3GPP) Radio Access Network (RAN) #72 Plenary decided to study New Radio (NR), or what is called the Fifth Generation (5G), and later at 3GPP RAN #75 Plenary, a Work Item (WI) was approved to standardize NR. In response to rapid growth of Vehicle-to-Everything (V2X) traffics, 3GPP has also started Sidelink (SL) standard planning and research work under the framework of NR. In Internet of Vehicle (IoV) traffic, in addition to vehicle terminals, there are also roadside pedestrian handheld terminals, which are power constrained and power-consumption-sensitive. Therefore, it was decided at 3GPP RAN #86 plenary meeting to initiate a Work Item (WI) to standardize NR V2X DRX.

### SUMMARY

Inventors have found through researches that after introducing a DRX in sidelink transmission, if active time and inactive time of a transmitting User Equipment (UE) and a receiving UE are not synchronized, the receiving UE is in inactive time when the transmitting UE transmits a radio signal to the receiving UE, resulting in the receiving UE unable to receive and give feedback, which further makes the transmitting UE trigger an unnecessary RLF.

To solve the above problems, the present disclosure discloses a Hybrid Automatic Repeat Request (HARQ)-based RLF detection solution when DRX is supported on sidelink. When the transmitting UE detects a HARQ-based RLF, it tries to exclude the false detection caused by the unsynchronized transmitting UE and receiving UE, so as to reduce the false judgment of RLF caused by supporting DRX. Though the present disclosure only took the NR V2X scenario as a typical application scenario or an example in the statement above; it is also applicable to other scenarios confronting the similar problems (e.g., relay networks, Device-to-Device (D2D) networks, cellular networks, and scenarios supporting Half Duplex UE), where similar technical effects can be achieved. Additionally, the adoption of a unified solution for various scenarios, including but not limited to NR V2X and downlink communications, contributes to the reduction of hardcore complexity and costs. If no conflict is incurred, embodiments in the first node in the present disclosure and the characteristics of the embodiments can also be applicable to any other node, and vice versa. And the embodiments in the present disclosure and the characteristics in the embodiments can be arbitrarily combined if there is no conflict. Particularly, for interpretations of the terminology, nouns, functions and variants (if not specified) in the present disclosure, refer to definitions given in TS36 series, TS38 series and TS37 series of 3GPP specifications.

The present disclosure provides a method in a first node for wireless communications, comprising:

transmitting a first signaling and a first radio signal;

monitoring a second signaling;

maintaining a first counter according to whether the second signaling is received; and

as a response to a value of the first counter reaching a first threshold, determining an RLF for a second node;

herein, the first signaling comprises configuration information of the first radio signal; the second signaling is used to indicate whether the first radio signal is correctly decoded; the behavior of maintaining a first counter according to whether the second signaling is received comprises: when the second signaling is received, updating the value of the first counter to an initial value; when the second signaling is not received and a time for transmitting the first signaling belongs to an active estimation time, updating the value of the first counter by 1; when the second signaling is not received and the time for transmitting the first signaling does not belong to the active estimation time, keeping the value of the first counter unchanged; the active estimated time comprises a time when a first timer is in a running state.

In one embodiment, when the transmitting UE transmits data and enables a HARQ feedback, and if the transmitting UE does not receive a HARQ-ACK feedback on feedback resources, the transmitting UE identifies a HARQ DTX.

In one embodiment, the present disclosure is applicable to HARQ-based sidelink RLF detection scenarios.

In one subembodiment of the above embodiment, a number of consecutive HARQ DTXs is counted and an RLF is triggered when the number reaches a given first threshold.

In one embodiment, a problem to be solved in the present disclosure is: in the scenario where the receiving UE is configured with a HARQ DRX, if the receiving UE is in inactive time during a transmission of the transmitting UE, the receiving UE cannot monitor and receive data, nor can it feed back ACKnowledgement/Negative ACKnowledgment (ACK/NACK), and the transmitting UE recognizes a HARQ DTX; if the transmitting UE does not distinguish whether the receiving UE is in active time or inactive time when counting a number of HARQ DTXs, it leads to the transmitting UE to trigger an unnecessary RLF.

In one embodiment, a solution of the present disclosure includes: the transmitting UE counts a number of HARQ DTXs only for a transmission performed when the receiving UE is confirmed to be in active time, and does not count a number of the HARQ DTXs for a transmission performed when the receiving UE is not confirmed to be in active time.

In one embodiment, a beneficial effect of the present disclosure includes: the transmitting UE only counts a number of HARQ DTXs for a transmission performed when the receiving UE is confirmed to be in active time, which can effectively reduce the false counting caused by the receiving UE in inactive time, thus reducing the risk of triggering an unnecessary RLF.

In one embodiment, when the second signaling is not received and the time for transmitting the first signaling does not belong to the active estimation time, it is determined that the second node is not in active time, keeping the value of the first counter unchanged.

In one subembodiment of the above embodiment, when the second node is not in active time, the first node not counting a HARQ DTX can reduce the risk of the first counter reaching the first threshold, thus further reducing the risk of triggering an RLF.

According to one aspect of the present disclosure, comprising:

the active estimation time comprising a time when a second timer is in a running state.

According to one aspect of the present disclosure, comprising:

transmitting a third signaling and a second radio signal; and

receiving a fourth signaling;

herein, the fourth signaling is used to indicate whether the second radio signal is correctly decoded, the fourth signaling comprises a last received HARQ-ACK from the second node, and the active estimation time comprises time-domain resources lasting a first time length from an end time for transmitting the third signaling.

According to one aspect of the present disclosure, comprising:

when the second signaling is not received and the time for transmitting the first signaling does not belong to the active estimation time, dropping a continuation of transmitting a radio signal to the second node after transmitting the first radio signal;

herein, the second node has at least two communication correspondences, and the first node is one of the at least two communication correspondences; the at least two communication correspondences are not quasi co-located.

In one embodiment, when the second signaling is not received and the time for transmitting the first signaling does not belong to the active estimation time, the first node judges that the second node is in inactive time and stops transmitting a radio signal to the second node.

In one embodiment, when the second signaling is not received and the time for transmitting the first signaling does not belong to the active estimation time, dropping a continuation of transmitting a radio signal to the second node after transmitting the first radio signal can avoid an invalid transmission of the radio signal due to the second node being in the inactive time, and the waste of the power of the first node can be avoided at the same time.

According to one aspect of the present disclosure, comprising:

the second node is configured with a DRX.

According to one aspect of the present disclosure, comprising:

transmitting first information;

herein, the first information comprises an expiration value of the first timer.

The present disclosure provides a first node for wireless communications, comprising:

a first transmitter, transmitting a first signaling and a first radio signal; and

a first receiver, monitoring a second signaling; maintaining a first counter according to whether the second signaling is received; and as a response to a value of the first counter reaching a first threshold, determining an RLF for a second node;

herein, the first signaling comprises configuration information of the first radio signal; the second signaling is used to indicate whether the first radio signal is correctly decoded; the behavior of maintaining a first counter according to whether the second signaling is received comprises: when the second signaling is received, updating the value of the first counter to an initial value; when the second signaling is not received and a time for transmitting the first signaling belongs to an active estimation time, updating the value of the first counter by 1; when the second signaling is not received and the time for transmitting the first signaling does not belong to the active estimation time, keeping the value of the first counter unchanged; the active estimated time comprises a time when a first timer is in a running state.

### BRIEF DESCRIPTION OF THE DRAWINGS

Other features, objects and advantages of the present disclosure will become more apparent from the detailed description of non-restrictive embodiments taken in conjunction with the following drawings:

FIG. 1 illustrates a flowchart of transmission of a first node according to one embodiment of the present disclosure;

FIG. 2 illustrates a schematic diagram of a network architecture according to one embodiment of the present disclosure;

FIG. 3 illustrates a schematic diagram of a radio protocol architecture of a user plane and a control plane according to one embodiment of the present disclosure;

FIG. 4 illustrates a schematic diagram of hardware modules of a communication device according to one embodiment of the present disclosure;

FIG. 5 illustrates a flowchart of radio signal transmission according to one embodiment of the present disclosure;

FIG. 6 illustrates a schematic diagram of a second signaling according to one embodiment of the present disclosure;

FIG. 7 illustrates a schematic diagram of running of a first counter according to one embodiment of the present disclosure;

FIG. 8 illustrates a schematic diagram of an active estimation time according to one embodiment of the present disclosure;

FIG. 9 illustrates a schematic diagram of another active estimation time according to one embodiment of the present disclosure;

FIG. 10 illustrates a schematic diagram of running of a timer according to one embodiment of the present disclosure;

FIG. 11 illustrates a schematic diagram of a sidelink slot according to one embodiment of the present disclosure;

FIG. 12 illustrates a structure block diagram of a processing device in a first node according to one embodiment of the present disclosure.

### DESCRIPTION OF THE EMBODIMENTS

The technical scheme of the present disclosure is described below in further details in conjunction with the drawings. It should be noted that the embodiments of the present disclosure and the characteristics of the embodiments may be arbitrarily combined if no conflict is caused.

### Embodiment 1

Embodiment 1 illustrates a flowchart of transmission of a first node according to one embodiment of the present disclosure, as shown in FIG. 1.

In embodiment 1, a first node 100 transmits a first signaling and a first radio signal in step 101;

monitors a second signaling in step 102; maintains a first counter according to whether the second signaling is received in step 103; and as a response to a value of the first counter reaching a first threshold, determines an RLF for a second node in step 104; herein, the first signaling comprises configuration information of the first radio signal; the second signaling is used to indicate whether the first radio signal is correctly decoded; the behavior of maintaining a first counter according to whether the second signaling is received comprises: when the second signaling is received, updating the value of the first counter to an initial value; when the second signaling is not received and a time for transmitting the first signaling belongs to an active estimation time, updating the value of the first counter by 1; when the second signaling is not received and the time for transmitting the first signaling does not belong to the active estimation time, keeping the value of the first counter unchanged; the active estimated time comprises a time when a first timer is in a running state.

In one embodiment, the first signaling is transmitted via an air interface.

In one embodiment, the first signaling is transmitted via a PC5 interface.

In one embodiment, the first signaling is transmitted through sidelink.

In one embodiment, the first signaling is a physical-layer signaling.

In one embodiment, the first signaling is a dynamic signaling.

In one embodiment, the first signaling is UE-specific.

In one embodiment, the first signaling is UE group-specific.

In one embodiment, the first signaling is traffic-specific.

In one embodiment, the first signaling is a Physical Sidelink Control Channel (PSCCH).

In one embodiment, the second node is a receiver of the first radio signal.

In one embodiment, the first signaling comprises at least partial bits of an ID of the second node.

In one embodiment, the first radio signal comprises at least partial bits of the ID of the second node.

In one embodiment, the first radio signal comprises a first Medium Access Control (MAC) Protocol Data Unit (PDU), and the first MAC PDU comprises at least one partial bits of the ID of the second node.

In one embodiment, the first signaling and the first radio signal comprises the ID of the second node.

In one embodiment, a destination ID comprised in the first signaling and a DST comprised in the first radio signal are used to jointly indicate the ID of the second node.

In one embodiment, a destination ID comprised in the first signaling comprises lower 16 bits of the ID of the second node.

In one embodiment, a DST comprised in the first radio signal comprises higher 8 bits of the ID of the second node.

In one embodiment, the ID of the second node comprises 24 bits.

In one embodiment, the ID of the second node comprises a link-layer ID.

In one embodiment, the ID of the second node comprises a destination layer 2 ID.

In one subembodiment of the above embodiment, the destination layer 2 ID indicates the second node in unicast communications.

In one subembodiment of the above embodiment, the destination layer 2 ID indicates a groupcast group in groupcast communications.

In one subembodiment of the above embodiment, the destination layer 2 ID indicates a broadcast traffic in groupcast communications.

In one embodiment, the first signaling comprises at least partial bits of an ID of the first node.

In one embodiment, the first radio signal comprises at least partial bits of the ID of the first node.

In one embodiment, the first signaling comprises a source ID.

In one embodiment, the first signaling and the first radio signal comprise the ID of the first node.

In one embodiment, a source ID comprised in the first signaling and an SRC comprised in the first radio signal are used to jointly indicate the ID of the first node.

In one embodiment, the ID of the first node comprises 24 bits.

In one embodiment, the ID of the first node comprises a link-layer ID.

In one embodiment, the ID of the first node comprises a source layer 2 ID; and the source layer 2 ID indicates the first node.

In one embodiment, the source ID comprised in the first signaling comprises lower 8 bits of the ID of the first node.

In one embodiment, the source comprised in the first radio signal comprises higher 16 bits of the ID of the first node.

In one embodiment, the first signaling comprises Sidelink Control Information (SCI).

In one embodiment, the first signaling comprises 2^{nd}-stage SCI.

In one embodiment, the first signaling comprises 1^{st}-stage SCI and a 2^{nd}-stage SCI.

In one embodiment, the first signaling comprises SCI format 1-A and SCI format 2, and the SCI format 2 comprises SCI format 2-A or SCI format 2-B.

In one embodiment, the SCI format 1-A in the first signaling is transmitted through a PSCCH.

In one embodiment, the SCI format 2 in the first signaling occupies Physical Sidelink Shared Channel (PSSCH) resources.

In one embodiment, the SCI format 2 in the first signaling is transmitted through a PSSCH.

In one embodiment, the first signaling indicates that a HARQ feedback is enabled.

In one embodiment, the first signaling comprises configuration information of the first radio signal.

In one embodiment, the configuration information is scheduling information.

In one embodiment, the configuration information comprises a cast type, and the cast type indicates that a transmission type is one of unicast, groupcast or broadcast.

In one embodiment, the configuration information of the first radio signal comprises time-frequency resources occupied by the scheduled first radio signal.

In one embodiment, the configuration information of the first radio signal comprises a modulation coding mode of the scheduled first radio signal.

In one embodiment, the configuration information of the first radio signal comprises information required to decode a first bit block.

In one embodiment, all or part of the first bit block is used to generate the first radio signal.

In one embodiment, all or part of the first bit block and a reference signal are used to generate the first radio signal.

In one embodiment, the first radio signal is acquired after all or partial bits in the first bit block sequentially through CRC Calculation, Channel Coding, Rate matching, Scrambling, Modulation, Layer Mapping, Antenna Port Mapping, Mapping to Virtual Resource Blocks, Mapping from Virtual to Physical Resource Blocks, OFDM Baseband Signal Generation, Modulation and Upconversion Channel Coding.

In one embodiment, the first radio signal is a Physical Sidelink Shared Channel (PSSCH).

In one embodiment, the first radio signal is transmitted via an air interface.

In one embodiment, the first radio signal is transmitted via a PC5 interface.

In one embodiment, the first radio signal is transmitted through SL.

In one embodiment, time-frequency resources occupied by the first signaling and the first radio signal are reserved for a sidelink transmission.

In one embodiment, time-frequency resources occupied by the first signaling and the first radio signal belong to a first resource pool; and the first resource pool is reserved for a sidelink transmission.

In one embodiment, a slot where a start time for transmitting the first signaling is located is the same as a slot where a start time for transmitting the first radio signal.

In one embodiment, a second signaling is monitored, and the second signaling is used to indicate whether the first radio signal is correctly decoded.

In one embodiment, time-frequency resources occupied by the second signaling and time-frequency resources occupied by the first signaling belong to a same resource pool.

In one embodiment, the meaning of the monitoring includes searching.

In one embodiment, the meaning of monitoring includes monitoring.

In one embodiment, the phrase of monitoring a second signaling includes: determining whether the second signaling exists through an energy monitoring.

In one embodiment, the phrase of monitoring a second signaling includes: determining whether the second signaling exists through a coherent detection.

In one embodiment, the phrase of monitoring a second signaling includes: determining whether the second signaling exists through a bandwidth detection.

In one embodiment, the phrase of monitoring a second signaling includes: determining whether the second signaling exists through a related detection.

In one embodiment, the phrase of monitoring a second signaling includes: determining whether the second signaling exists through a synchronization detection.

In one embodiment, the phrase of monitoring a second signaling includes: determining whether the second signaling exists through a waveform detection.

In one embodiment, the phrase of monitoring a second signaling includes: determining whether the second signaling exists through a maximum likelihood detection.

In one embodiment, the phrase of monitoring a second signaling includes: determining whether the second signaling exists through a blind decoding detection.

In one embodiment, the phrase of monitoring a second signaling includes: monitoring the second signaling in the first resource pool.

In one embodiment, the phrase of monitoring a second signaling includes: monitoring the second signaling in a first Physical Sidelink Feedback CHannel (PSFCH) resource.

In one embodiment, the second signaling occupies the first PSFCH resource.

In one embodiment, the first PSFCH resource comprises frequency-domain resources and cyclic shift resources.

In one embodiment, the second signaling is transmitted via a PC5 interface.

In one embodiment, the second signaling is transmitted through SL.

In one embodiment, the second signaling is physical-layer signaling

In one embodiment, the second signaling is a PSFCH.

In one embodiment, the second signaling comprises a HARQ-ACK.

In one embodiment, the HARQ-ACK comprises one of an ACK or a NACK.

In one embodiment, the HARQ-ACK comprises only an ACK.

In one embodiment, the HARQ-ACK comprises only a NACK.

In one embodiment, when the second signaling is monitored, the second signaling is received; when the second signaling is not monitored, the second signaling is not received.

In one embodiment, when the second signaling is received and the second signaling is an ACK, it indicates that the first radio signal is correctly decoded.

In one embodiment, when the second signaling is received and the second signaling is a NACK, it indicates that the first radio signal is not correctly decoded.

In one embodiment, a first counter is maintained according to whether the second signaling is received.

In one embodiment, the first counter is maintained at a higher layer of the first node.

In one embodiment, the first counter is maintained at the MAC sublayer.

In one embodiment, the first counter is maintained at a sidelink HARQ entity.

In one embodiment, the first counter is used to count a number of continuous HARQ DTXs when the first node and the second node are in sidelink communications.

In one embodiment, a value of the first counter is updated to an initial value when the first counter is initialized.

In one embodiment, a time when the first counter is initialized comprises a time when the first node is powered on.

In one embodiment, a time when the first counter is initialized comprises a time when the first counter is configured.

In one embodiment, a time when the first counter is initialized comprises a time when an RRC connection is established between the second node and the first node.

In one subembodiment of the above embodiment, the RRC connection is a PC5-RRC connection.

In one embodiment, the behavior of maintaining a first counter according to whether the second signaling is received includes: when the second signaling is received, updating the value of the first counter to an initial value; when the second signaling is not received and a time for transmitting the first signaling belongs to an active estimation time, updating the value of the first counter by 1; when the second signaling is not received and the time for transmitting the first signaling does not belong to the active estimation time, keeping the value of the first counter unchanged.

In one embodiment, the initial value is pre-configured.

In one embodiment, the initial value is pre-specified.

In one embodiment, the initial value is configured by the base station.

In one embodiment, the initial value is comprised in a System Information Block (SIB).

In one embodiment, the initial value is determined by UE implementation.

In one embodiment, the initial value is determined by the first node and the second node through negotiation.

In one embodiment, the initial value is 0.

In one embodiment, the initial value is a value of sl-maxNumConsecutiveDTX.

In one embodiment, the phrase of updating the value of the first counter by 1 includes: increasing the value of the first counter by 1.

In one embodiment, the phrase of updating the value of the first counter by 1 includes: decreasing the value of the first counter by 1.

In one embodiment, when the second signaling is not received and the time for transmitting the first signaling belongs to the active estimation time, it is determined that HARQ DTX occurs once.

In one embodiment, as a response to a value of the first counter reaching a first threshold, an RLF for a second node is determined.

In one embodiment, the first threshold is pre-configured.

In one embodiment, the first threshold is pre-specified.

In one embodiment, the first threshold is configured by an RRC signaling.

In one embodiment, the first threshold is configured by a PC5-RRC signaling.

In one embodiment, the first threshold is configured by a base station.

In one embodiment, the first threshold is comprised in all or partial IEs in an RRC signaling.

In one embodiment, the first threshold is comprised in all or partial fields in an IE in an RRC signaling

In one embodiment, the first threshold is comprised in a System Information Block (SIB).

In one embodiment, the first threshold is determined by UE implementation.

In one embodiment, a name of the first threshold comprises DTX.

In one embodiment, the name of the first threshold comprises sl-maxNumConsecutiveDTX.

In one embodiment, the first threshold is used by the first node to trigger an RLF.

In one embodiment, the phrase of updating the value of the first counter to the initial value includes: setting the value of the first counter to 0; the phrase of updating the value of the first counter by 1 includes: increasing the value of the first counter by 1; the phrase of when the value of the first counter reaching the first threshold includes: when the value of the first counter reaches a value of the sl-maxNumConsecutiveDTX.

In one embodiment, the phrase of updating the value of the first counter to the initial value includes: setting the value of the first counter as a value of the sl-maxNumConsecutiveDTX; the phrase of updating the value of the first counter by 1 includes: decreasing the value of the first counter by 1; the phrase of when the value of the first counter reaching the first threshold includes: when the value of the first counter reaches 0.

In one embodiment, when the value of the first counter reaches the first threshold, an indication is transmitted to an RRC sublayer of the first node, and an RLF for the second node is determined.

In one embodiment, when an RLF for a second node is determined, the first node releases a Data Radio Bearer (DRB) of the second node.

In one embodiment, when an RLF for a second node is determined, the first node releases a Signaling Radio Bearer (SRB) of the second node.

In one embodiment, when an RLF for a second node is determined, the first node drops a new radio sidelink communication configuration for the second node.

In one embodiment, when an RLF for a second node is determined, the first node resets the second node-specific MAC configuration.

In one embodiment, when an RLF for a second node is determined, the first node considers that a PC5-RRC connection for the second node is released.

In one embodiment, when an RLF for a second node is determined, the first node indicates a release for a PC5-RRC connection for the second node to the higher layer of the first node.

In one embodiment, when an RLF for a second node is determined and the first node is in an RRC connection state, the first node transmits auxiliary information to a serving base station of the first node.

In one subembodiment of the above embodiment, the auxiliary information is SidelinkUEInformationNR.

In one embodiment, the active estimation time comprises a time when a first timer is in a running state.

In one embodiment, the first timer is maintained by the second node, and an active time of the second node comprises the time when the first timer is in a running state.

In one embodiment, the time when the first timer is in a running state is pre-configured.

In one embodiment, the time when the first timer is in a running state is configured by a base station.

In one embodiment, the time when the first timer is in a running state is determined by the first node and the second node through negotiation.

In one embodiment, the first node maintains a timer fully synchronized with the first timer.

In one embodiment, the phrase of the first node maintaining a timer fully synchronized with the first timer includes: a start/restart time of the timer fully synchronized with the first timer maintained by the first node is the same as a start/restart time of the first timer; and an expiration value of the timer fully synchronized with the first timer maintained by the first node is the same as an expiration value of the first timer.

In one embodiment, a name of the first timer comprises onDuration.

In one embodiment, a name of the first counter comprises drx-onDurationTimer.

In one embodiment, the first timer is sl-drx-onDurationTimer.

In one embodiment, the first timer starts running in each DRX cycle.

In one embodiment, the time of the first timer being in a running state in each DRX cycle is not greater than the DRX cycle.

In one embodiment, an expiration value of the first timer is the time when the first timer is in a running state in each DRX cycle.

In one embodiment, the first timer and a timer fully synchronized with the first timer maintained by the first node determine a subframe number that starts running in each DRX cycle according to an sl-drx-Cycle and an sl-drx-StartOffset respectively; herein, the sl-drx-Cycle indicates the cycle of the first timer, and the sl-drx-StartOffset indicates a subframe number that the first timer starts running.

In one embodiment, the first timer and a timer fully synchronized with the first timer maintained by the first node determine a slot number that the first timer starts running according to an sl-drx-slotOffset respectively; herein, the sl-drx-slotOffset indicates a slot offset of the first timer in a subframe that starts running.

In one embodiment, the first node and the second node are synchronized.

In one embodiment, the first node and the second node are synchronized in time.

In one embodiment, the first node and the second node maintain a same subframe number and a subframe start time.

In one embodiment, the first node and the second node are synchronized in frequency.

In one embodiment, the sl-drx-Cycle, the sl-drx-StartOffset, the sl-drx-slotOffset and sl-drx-onDurationTimer are configured by a DRX parameter.

In one embodiment, the sl-drx-onDurationTimer indicates the expiration value of the first timer.

In one embodiment, the active estimation time comprises a time from a start/restart of running of the first timer to a current expiration of the first timer.

In one embodiment, the active estimation time comprises a smaller one of a time from a start/restart of running of the first timer to a current expiration of the first timer or a time from a start/restart of running of the first timer to an end time for receiving a first MAC Control Element (CE); herein, an end time for receiving the first MAC CE is earlier than a time of the current expiration of the first timer.

In one embodiment, the active estimation time comprises a duration from a start/restart of the timer fully synchronized with the first timer maintained by the first node to the expiration of the timer fully synchronized with the first timer maintained by the first node.

In one embodiment, the active estimation time comprises a smaller one of a duration from a start/restart of the timer fully synchronized with the first timer maintained by the first node to the current expiration of the timer fully synchronized with the first timer maintained by the first node or a duration from a start/restart of the timer fully synchronized with the first timer maintained by the first node to an end time for transmitting a first MAC CE; herein, an end time for transmitting the first MAC CE is earlier than a time of the current expiration of the timer fully synchronized with the first timer maintained by the first node.

In one embodiment, the first MAC CE is used to stop the first timer.

In one embodiment, a first MAC CE is a DRX Command MAC CE.

### Embodiment 2

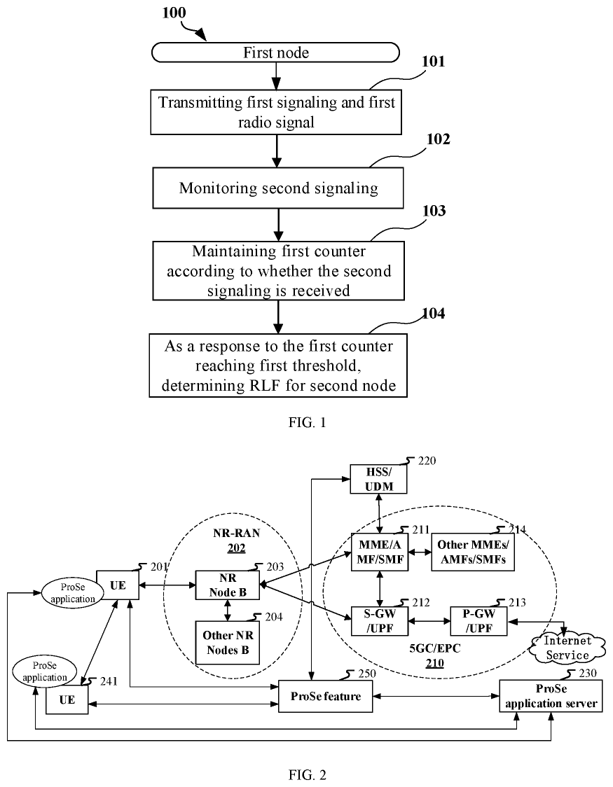

Embodiment 2 illustrates a schematic diagram of a network architecture according to one embodiment of the present disclosure, as shown in FIG. 2. FIG. 2 illustrates a V2X communication architecture under NR 5G, Long-Term Evolution (LTE), and Long-Term Evolution Advanced (LTE-A) systems. The NR 5G, LTE or LTE-A network architecture may be called a 5G System (5GS)/Evolved Packet System (EPS) or other appropriate terms.

The V2X communication architecture in Embodiment 2 may comprise a UE 201, a UE 241 in communication with UE 201, an NG-RAN 202, a 5G Core Network/Evolved Packet Core (5GC/EPC) 210, a Home Subscriber Server (HSS)/Unified Data Management (UDM) 220, a ProSe feature 250 and a ProSe application server 230. The V2X communication architecture may be interconnected with other access networks. For simple description, the entities/interfaces are not shown. As shown in FIG. 2, the V2X communication architecture provides packet switching services. Those skilled in the art will readily understand that various concepts presented throughout the present disclosure can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmit-Receive Point (TRP) or some other applicable terms. In NTN network, the gNB 203 may be a satellite, an aircraft or a territorial base station relayed through a satellite. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, vehicle equipment, On-board communication unit, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet service. The Internet Service comprises IP services corresponding to operators, specifically including Internet, Intranet, IP Multimedia Subsystem (IMS) and Packet Switching Streaming Services (PSS). The ProSe feature 250 refers to logical functions of network-related actions needed for Proximity-based Service (ProSe), including Direct Provisioning Function (DPF), Direct Discovery Name Management Function and EPC-level Discovery ProSe Function. The ProSe application server 230 is featured with functions like storing EPC ProSe user ID, and mapping between an application-layer user ID and an EPC ProSe user ID.

In one embodiment, the UE 201 corresponds to the first node in the present disclosure.

In one embodiment, the UE 241 corresponds to the second node in the present disclosure.

In one embodiment, the UE 201 and the UE 241 support SL communications.

In one embodiment, the UE 201 and the UE 241 respectively support a PC5 interface.

In one embodiment, the UE 201 and the UE 241 respectively support Internet of Vehicles (IoVs).

In one embodiment, the UE 201 and the UE 241 respectively support V2X traffic.

In one embodiment, the UE 201 and the UE 241 respectively support D2D traffic.

In one embodiment, the UE 201 and the UE 241 respectively support public safety traffic.

In one embodiment, the gNB 203 supports Internet of Vehicles (IoVs).

In one embodiment, the gNB 203 supports V2X traffic.

In one embodiment, the gNB 203 supports D2D traffic.

In one embodiment, the gNB 203 supports public safety traffic.

In one embodiment, the gNB 203 is a Marco Cell base station.

In one embodiment, the gNB 203 is a Micro Cell base station.

In one embodiment, the gNB 203 is a Pico Cell base station.

In one embodiment, the gNB 203 is a Femtocell.

In one embodiment, the gNB 203 is a base station supporting large delay differences.

In one embodiment, the gNB 203 is a flight platform.

In one embodiment, the gNB 203 is satellite equipment.

In one embodiment, a radio link between the UE 201 to the gNB 203 is an uplink.

In one embodiment, a radio link between the gNB 203 to the UE 201 is a downlink

In one embodiment, a radio link between the UE 201 and the UE 241 corresponds to a sidelink in the present disclosure.

In one embodiment, the UE 201 and the gNB 203 are connected via a Uu interface.

In one embodiment, the UE 201 and the UE 241 are connected via a PC5 reference point.

In one embodiment, the ProSe feature 250 is connected with the UE 201 and the UE 241 respectively via a PC3 reference point.

In one embodiment, the ProSe feature 250 is connected with the ProSe application server 230 via a PC2 reference point.

In one embodiment, the ProSe application server 230 is connected with the ProSe application of the UE 201 and the ProSe application of the UE 241 respectively via a PC1 reference point.

### Embodiment 3

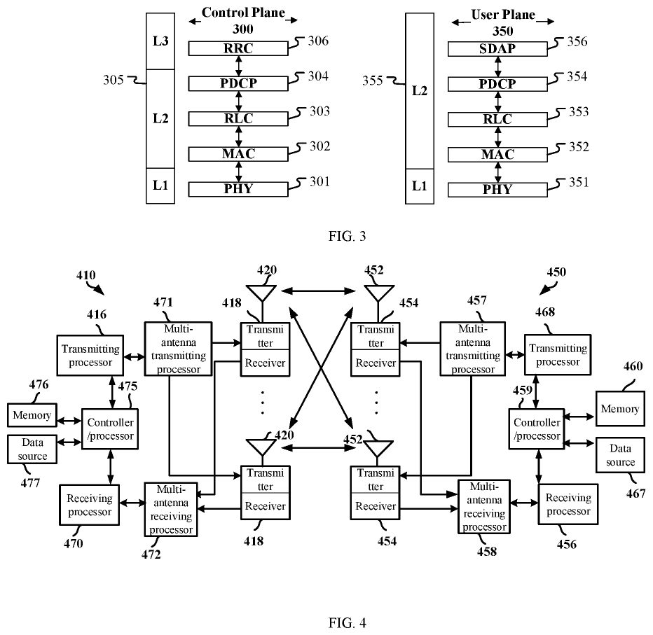

Embodiment 3 illustrates a schematic diagram of a radio protocol architecture of a user plane and a control plane according to one embodiment of the present disclosure, as shown in FIG. 3. FIG. 3 is a schematic diagram illustrating an embodiment of a radio protocol architecture of a user plane 350 and a control plane 300. In FIG. 3, the radio protocol architecture for the control plane 300 of a UE and a gNB is represented by three layers, which are a layer 1, a layer 2 and a layer 3, respectively. The layer 1 (L1) is the lowest layer and performs signal processing functions of various PHY layers. The L1 is called PHY 301 in the present disclosure. The layer 2 (L2) 305 is above the PHY 301, and is in charge of the link between the UE and the gNB via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the gNBs of the network side. The PDCP sublayer 304 provides data encryption and integrity protection and also provides support for a UE handover between gNBs. The RLC sublayer 303 provides segmentation and reassembling of a packet, retransmission of a lost data packet through ARQ, as well as repeat data packet detection and protocol error detection. The MAC sublayer 302 provides mapping between a logic channel and a transport channel and multiplexing of the logical channel ID. The MAC sublayer 302 is also responsible for allocating between UEs various radio resources (i.e., resources block) in a cell. The MAC sublayer 302 is also responsible for Hybrid Automatic Repeat Request (HARQ) operation. The Radio Resource Control (RRC) sublayer 306 in layer 3 (L3) of the control plane 300 is responsible for acquiring radio resources (i.e., radio bearer) and configuring the lower layer with an RRC signaling between the gNB and the UE. Although not shown, the RRC sublayer 306 in the control plane 300 of the UE may also have a V2X layer, and the V2X layer is responsible for generating a PC5 QoS parameter group and QoS rules according to received service data or service requests, a PC5 QoS flow is generated corresponding to a PC5 QoS parameter group, and a PC5 QoS flow ID and the corresponding PC5 QoS parameter group are transmitted to an Access Stratum (AS) Layer for QoS processing of a packet belonging to the PC5 QoS flow ID by the AS layer; the V2X layer also comprises a PC5-Signaling Protocol sublayer, and the V2X layer is responsible for indicating whether each transmission of the AS layer is a PC5-S transmission or a V2X service data transmission. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. The radio protocol architecture of the UE in the user plane 350 may comprises part or all of protocol sublayers of the SDAP sublayer 356, the PDCP sublayer 354, the RLC sublayer 353 and the MAC sublayer 352 at L2 layer. Although not described in FIG. 3, the UE may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present disclosure.

In one embodiment, the radio protocol architecture in FIG. 3 is applicable to the second node in the present disclosure.

In one embodiment, the first signaling in the present disclosure is generated by the PHY 301 or the PHY 351.

In one embodiment, the first radio signal in the present disclosure is generated by the PHY 301 or the PHY 351.

In one embodiment, the second signaling in the present disclosure is generated by the PHY 301 or the PHY 351.

In one embodiment, the third signaling in the present disclosure is generated by the PHY 301 or the PHY 351.

In one embodiment, the second radio signal in the present disclosure is generated by the PHY 301 or the PHY 351.

In one embodiment, the fourth signaling in the present disclosure is generated by the PHY 301 or the PHY 351.

In one embodiment, the first information in the present disclosure is generated by the RRC 306.

In one embodiment, the first counter in the present disclosure is maintained by the MAC 302 or the MAC 352.

In one embodiment, the first timer in the present disclosure is maintained by the MAC 302 or the MAC 352.

In one embodiment, the second timer in the present disclosure is maintained by the MAC 302 or the MAC 352.

In one embodiment, the L2 layer 305 belongs to a higher layer.

In one embodiment, the RRC sublayer 306 in the L3 layer belongs to a higher layer.

In one embodiment, the V2X layer belongs to a higher layer.

In one embodiment, the PC5-S in the V2X layer belongs to a higher layer.

### Embodiment 4

Embodiment 4 illustrates a schematic diagram of hardware modules of a communication device according to one embodiment of the present disclosure, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a data source 477, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from the core network or a higher layer packet from the data source 477 is provided to the controller/processor 475. The core network and the data source 477 represents all protocol layers above the L2 layer. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In a transmission from the second communication device 410 to the first communication device 450, the controller/processor 459 provides multiplexing between a transport channel and a logical channel, packet reassembling, decryption, header decompression, control signal processing so as to recover a higher-layer packet from the second communication device 410. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the first communication device 450. The higher layer packet from the controller/processor 475 can be provided to all protocol layers above the core network or the L2 layer, and various control signals can also be provided to the core network or L3 layer for L3 layer processing.

In one embodiment, the first communication device 450 comprises at least one processor and at least one memory. The at least one memory comprises computer program codes; the at least one memory and the computer program codes are configured to be used in collaboration with the at least one processor, the first communication device 450 at least: transmits a first signaling and a first radio signal; monitors a second signaling; maintains a first counter according to whether the second signaling is received; and as a response to a value of the first counter reaching a first threshold, determines an RLF for a second node; herein, the first signaling comprises configuration information of the first radio signal; the second signaling is used to indicate whether the first radio signal is correctly decoded; the behavior of maintaining a first counter according to whether the second signaling is received comprises: when the second signaling is received, updating the value of the first counter to an initial value; when the second signaling is not received and a time for transmitting the first signaling belongs to an active estimation time, updating the value of the first counter by 1; when the second signaling is not received and the time for transmitting the first signaling does not belong to the active estimation time, keeping the value of the first counter unchanged; the active estimated time comprises a time when a first timer is in a running state.

In one embodiment, the first communication device 450 comprises a memory that stores a computer readable instruction program. The computer readable instruction program generates an action when executed by at least one processor. The action includes: transmitting a first signaling and a first radio signal; monitoring a second signaling; maintaining a first counter according to whether the second signaling is received; and as a response to a value of the first counter reaching a first threshold, determining an RLF for a second node; herein, the first signaling comprises configuration information of the first radio signal; the second signaling is used to indicate whether the first radio signal is correctly decoded; the behavior of maintaining a first counter according to whether the second signaling is received comprises: when the second signaling is received, updating the value of the first counter to an initial value; when the second signaling is not received and a time for transmitting the first signaling belongs to an active estimation time, updating the value of the first counter by 1; when the second signaling is not received and the time for transmitting the first signaling does not belong to the active estimation time, keeping the value of the first counter unchanged; the active estimated time comprises a time when a first timer is in a running state.

In one embodiment, the second communication device 410 comprises at least one processor and at least one memory. The at least one memory comprises computer program codes; the at least one memory and the computer program codes are configured to be used in collaboration with the at least one processor.

In one embodiment, the second communication device 410 comprises a memory that stores a computer readable instruction program. The computer readable instruction program generates an action when executed by at least one processor.

In one embodiment, the first communication device 450 corresponds to a first node in the present disclosure.

In one embodiment, the second communication device 410 corresponds to a second node in the present disclosure.

In one embodiment, the first communication device 450 is a UE.

In one embodiment, the first communication device 450 is a UE supporting V2X.

In one embodiment, the first communication device 450 is a UE supporting D2D.

In one embodiment, the first communication device 450 is an on-board device.

In one embodiment, the first communication device 450 is an RSU.

In one embodiment, the second communication device 410 is a UE.

In one embodiment, the second communication device 410 is a UE supporting V2X.

In one embodiment, the second communication device 410 is a UE supporting D2D.

In one embodiment, the second communication device 410 is an on-board device.

In one embodiment, the second communication device 410 is an RSU.

In one embodiment, the second communication device 410 is a base station.

In one embodiment, at least one of the antenna 452, the transmitter 454, the multi-antenna transmitting processor 457, the transmitting processor 468 or the controller/processor 459 is used to transmit a first signaling in the present disclosure.

In one embodiment, at least one of the antenna 420, the receiver 418, the multi-antenna receiving processor 472, the receiving processor 470 or the controller/processor 475 is used to receive a first signaling in the present disclosure.

In one embodiment, at least one of the antenna 452, the transmitter 454, the multi-antenna transmitting processor 457, the transmitting processor 468 or the controller/processor 459 is used to transmit a first radio signal in the present disclosure.

In one embodiment, at least one of the antenna 420, the receiver 418, the multi-antenna receiving processor 472, the receiving processor 470 or the controller/processor 475 is used to receive a first radio signal in the present disclosure.

In one embodiment, at least one of the antenna 420, the transmitter 418, the multi-antenna transmitting processor 471, the transmitting processor 416 or the controller/processor 475 is used to transmit a second signaling in the present disclosure.

In one embodiment, at least one of the antenna 452, the receiver 454, the multi-antenna receiving processor 458, the receiving processor 456 or the controller/processor 459 is used to receive a second signaling in the present disclosure.

In one embodiment, at least one of the antenna 452, the transmitter 454, the multi-antenna transmitting processor 457, the transmitting processor 468 or the controller/processor 459 is used to transmit a third signaling in the present disclosure.

In one embodiment, at least one of the antenna 420, the receiver 418, the multi-antenna receiving processor 472, the receiving processor 470 or the controller/processor 475 is used to receive a third signaling in the present disclosure.

In one embodiment, at least one of the antenna 452, the transmitter 454, the multi-antenna transmitting processor 457, the transmitting processor 468 or the controller/processor 459 is used to transmit a second radio signal in the present disclosure.

In one embodiment, at least one of the antenna 420, the receiver 418, the multi-antenna receiving processor 472, the receiving processor 470 or the controller/processor 475 is used to receive a second radio signal in the present disclosure.

In one embodiment, at least one of the antenna 420, the transmitter 418, the multi-antenna transmitting processor 471, the transmitting processor 416 or the controller/processor 475 is used to transmit a fourth signaling in the present disclosure.

In one embodiment, at least one of the antenna 452, the receiver 454, the multi-antenna receiving processor 458, the receiving processor 456 or the controller/processor 459 is used to receive a fourth signaling in the present disclosure.

In one embodiment, at least one of the antenna 452, the transmitter 454, the multi-antenna transmitting processor 457, the transmitting processor 468 or the controller/processor 459 is used to transmit first information in the present disclosure.

In one embodiment, at least one of the antenna 420, the receiver 418, the multi-antenna receiving processor 472, the receiving processor 470 or the controller/processor 475 is used to receive first information in the present disclosure.

### Embodiment 5

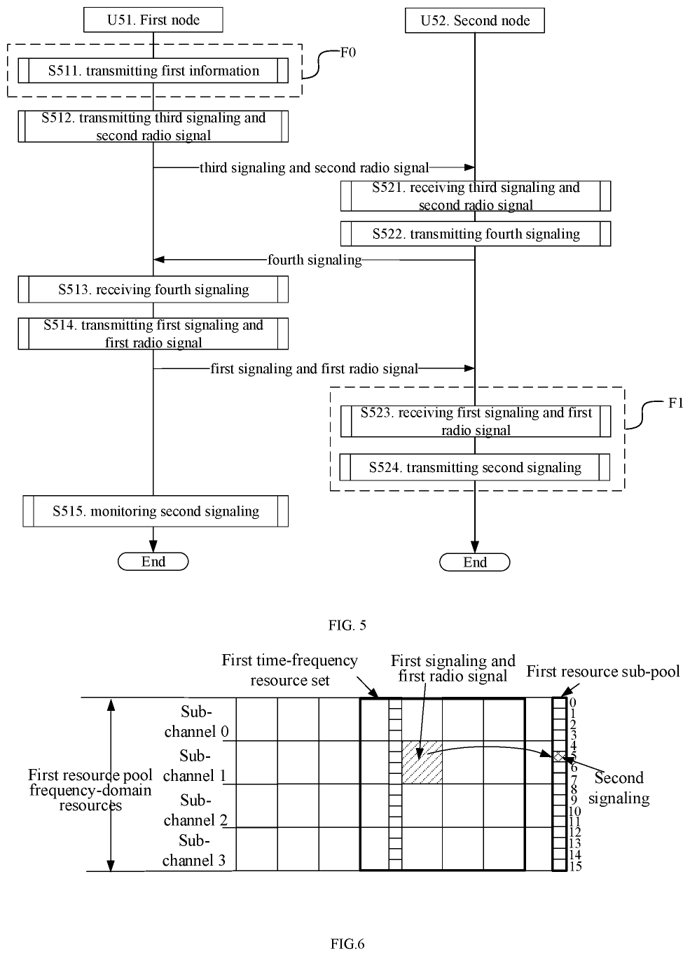

Embodiment 5 illustrates a flowchart of radio signal transmission according to one embodiment in the present disclosure, as shown in FIG. 5. Steps in dashed boxes F0 and F1 are optional.

The first node U1 transmits first information in step S511; transmits a third signaling and a second radio signal in step S512; receives a fourth signaling in step S513; transmits a first signaling and a first radio signal in step S514; and monitors a second signaling in step S515.

The second node U2 receives a third signaling and a second radio signal in step S521; transmits a fourth signaling in step S522; receives a first signaling and a first radio signal in step S523; and transmits a second signaling in step S524.

in embodiment 5, a first signaling and a first radio signal are transmitted; a second signaling is monitored; a first counter is maintained according to whether the second signaling is received; and as a response to a value of the first counter reaching a first threshold, an RLF for a second node is determined; herein, the first signaling comprises configuration information of the first radio signal; the second signaling is used to indicate whether the first radio signal is correctly decoded; the behavior of maintaining a first counter according to whether the second signaling is received comprises: when the second signaling is received, updating the value of the first counter to an initial value; when the second signaling is not received and a time for transmitting the first signaling belongs to an active estimation time, updating the value of the first counter by 1; when the second signaling is not received and the time for transmitting the first signaling does not belong to the active estimation time, keeping the value of the first counter unchanged; the active estimated time comprises a time when a first timer is in a running state; the active estimation time comprises a time when a second timer is in a running state; a third signaling and a second radio signal are transmitted; and a fourth signaling is received; herein, the fourth signaling is used to indicate whether the second radio signal is correctly decoded, the fourth signaling comprises a last received HARQ-ACK from the second node, and the active estimation time comprises time-domain resources lasting a first time length from an end time for transmitting the third signaling; when the second signaling is not received and the time for transmitting the first signaling does not belong to the active estimation time, dropping a continuation of transmitting a radio signal to the second node after transmitting the first radio signal; herein, the second node has at least two communication correspondences, and the first node is one of the at least two communication correspondences; the at least two communication correspondences are not quasi co-located; the second node is configured with a DRX; first information is transmitted; herein, the first information comprises an expiration value of the first timer.

In one embodiment, the second node transmits the second signaling

In one subembodiment of the above embodiment, the second node executes decoding on the first radio signal according to configuration information of the first radio signal comprised in the first signaling, and judges whether the decoding is correct according a Cyclic Redundancy Check (CRC); if the CRC check is not passed, the first radio signal is not correctly decoded; and if the CRC check is passed, the first radio signal is correctly decoded.

In one subembodiment of the above embodiment, when the first radio signal is correctly decoded, the second signaling is an ACK; and when the first radio signal is not correctly decoded, the second signaling is a NACK.

In one embodiment, the second node drops transmitting the second signaling.

In one subembodiment of the above embodiment, the second node does not receive the first signaling and the first radio signal.

In one subembodiment of the above embodiment, the second node receives the first signaling and the first radio signal, and a priority of the second signaling is lower than priorities of other signals/channels; time-domain resources occupied by other signals/channels are at least partially overlapping with time-domain resources occupied by the second signaling.

In one embodiment, the phrase of dropping the second signaling includes: the second node is in a receiving state.

In one embodiment, the phrase of dropping the second signaling includes: the second node executes an energy monitoring.

In one embodiment, the phrase of dropping the second signaling includes: the second node detects SCI and performs a Reference Signal Received Power (RSRP) detection according to a PSSCH scheduled by the SCI.

In one embodiment, the phrase of dropping the second signaling includes: the second node transmits a signaling/channel other than the second signaling.

In one embodiment, the active estimation time comprises a time when a second timer is in a running state.

In one embodiment, the second timer is maintained by the second node, and an active time of the second node comprises the time when the second timer is in a running state.

In one embodiment, the first node maintains a timer fully synchronized with the second timer.

In one embodiment, the phrase of the first node maintaining a timer fully synchronized with the second timer includes: a start/restart time of the timer fully synchronized with the second timer maintained by the first node is the same as a start/restart time of the second timer; and an expiration value of the timer fully synchronized with the second timer maintained by the first node is the same as an expiration value of the second timer.

In one embodiment, a name of the second timer comprises Retransmission.

In one embodiment, a name of the second timer comprises drx-RetransmissionTimer.

In one embodiment, the second timer is an sl-drx-RetransmissionTimer.

In one embodiment, a start time of the time when the second timer is in a running state is an end time of a third timer.

In one embodiment, an expiration value of the second timer is determined by UE implementation.

In one embodiment, the expiration value of the second timer is determined by network implementation.

In one embodiment, the expiration value of the second timer is pre-configured.

In one embodiment, the expiration value of the second timer is determined by the first node and the second node through negotiation.

In one embodiment, the third timer is maintained at the second node.

In one embodiment, the first node maintains a timer fully synchronized with the third timer.

In one embodiment, the phrase of the first node maintaining a timer fully synchronized with the third timer includes: a start/restart time of the timer fully synchronized with the third timer maintained by the first node is the same as a start/restart time of the third timer; and an expiration value of the timer fully synchronized with the third timer maintained by the first node is the same as an expiration value of the third timer.

In one embodiment, a name of the third timer comprises Round Trip Time (RTT).

In one embodiment, a name of the third timer comprises drx-HARQ-RTT-Timer.

In one embodiment, a name of the third timer is sl-drx-HARQ-RTT-Timer.

In one embodiment, the third timer is started/restarted when SCI transmitted by the first node indicates that a HARQ feedback is enabled.

In one embodiment, the third timer is started/restarted when SCI transmitted by the first node indicates that a HARQ feedback is enabled and a PSSCH scheduled by the SCI is not correctly decoded.

In one embodiment, the third timer does not start/restart when an SCI transmitted by the first node indicates that a HARQ feedback is enabled and a PSSCH scheduled by the SCI is correctly decoded.

In one embodiment, when SCI from the first node received by the second node indicates that a HARQ feedback is enabled, the third timer is started/restarted in a symbol or a slot immediately after transmitting a PSFCH corresponding to a PSSCH scheduled by the SCI to the first node.

In one embodiment, when SCI from the first node received by the second node indicates that a HARQ feedback is enabled, the third timer is started/restarted in a symbol or a slot immediately after transmitting a NACK corresponding to a PSSCH scheduled by the SCI to the first node.

In one embodiment, when SCI from the first node received by the second node indicates that a HARQ feedback is enabled and the second node drops transmitting a PSFCH corresponding to a PSSCH scheduled by the SCI to the first node, the third timer is started/restarted in a symbol or a slot immediately after the PSFCH resources.

In one embodiment, when SCI transmitted by the first node to the second node indicates that a HARQ feedback is enabled, a timer fully synchronized with the third timer maintained by the first node is started/restarted in a symbol or a slot immediately after PSFCH resources corresponding to a PSSCH scheduled by the SCI.

In one embodiment, when SCI transmitted by the first node to the second node indicates that a HARQ feedback is enabled and a PSFCH corresponding to a PSSCH scheduled by the SCI received by the first node is a NACK, a timer fully synchronized with the third timer maintained by the first node is started/restarted in a symbol or a slot immediately after the PSFCH resources corresponding to the PSSCH scheduled by the SCI.

In one embodiment, when SCI transmitted by the first node to the second node indicates that a HARQ feedback is enabled and a PSFCH corresponding to a PSSCH scheduled by the SCI received by the first node is an ACK, a timer fully synchronized with the third timer maintained by the first node is not started/restarted in a symbol or a slot immediately after the PSFCH resources corresponding to the PSSCH scheduled by the SCI.

In one embodiment, an expiration value of the third timer is determined according to a slot where retransmission resources indicated by an SCI transmitted by the first node is located and a slot where PSFCH resources corresponding to a PSSCH scheduled by the SCI is located.

In one embodiment, a time length between a slot where PSFCH resources corresponding to a PSSCH scheduled by an SCI transmitted by the first node and a slot where retransmission resources indicated by the SCI is the expiration value of the third timer.

In one embodiment, a PSSCH scheduled by SCI transmitted by the first node occupies slot 2, a PSFCH corresponding to the PSSCH occupies slot 5, a slot of retransmission resources indicated by the SCI is 12, and the expiration value determining the third timer is a time length comprised by 5 slots.

In one embodiment, when SCI does not indicate retransmission resources, the expiration value of the third timer is determined by UE implementation.

In one embodiment, when SCI does not indicate retransmission resources, the expiration value of the third timer is configured by the network.

In one embodiment, when SCI does not indicate retransmission resources, the expiration value of the third timer is pre-configured.

In one embodiment, when SCI does not indicate retransmission resources, the expiration value of the third timer is determined through by the first node and the second node through negotiation.

In one embodiment, when the third timer is started, the second timer is stopped.

In one embodiment, the second timer and the third timer are used in pairs.

In one embodiment, the second node maintains at least one HARQ process for the first node, and maintains at least one pair of a sl-drx-RetransmissionTimer and a sl-drx-HARQ-RTT-Timer for the at least one HARQ process.

In one embodiment, the second timer and the third timer is any pair of timers in the at least one pair of a sl-drx-RetransmissionTimer and a sl-drx-HARQ-RTT-Timer timer.

In one embodiment, a slot where a start time for transmitting the third signaling is located is the same as a slot where a start time for transmitting the second radio signal.

In one embodiment, a time for transmitting the third signaling is before the time for transmitting the first signaling.

In one embodiment, a time for transmitting the second radio signal is before the time for transmitting the first signaling.

In one embodiment, a time for receiving the fourth signaling is before the time for transmitting the first signaling.

In one embodiment, the fourth signaling and the second signaling belongs to a same type of signalings

In one embodiment, the fourth signaling is a PSFCH.

In one embodiment, the fourth signaling is used to indicate whether the second radio signal is correctly decoded.

In one embodiment, when the fourth signaling is an ACK, it indicates that the second radio signal is correctly decoded.

In one embodiment, when the fourth signaling is a NACK, it indicates that the second radio signal is not correctly decoded.

In one embodiment, the fourth signaling comprises a last received HARQ-ACK from the second node.

In one embodiment, the first node does not receive the HARQ-ACK from the second node after receiving the fourth signaling and before transmitting the first signaling.

In one embodiment, the first node transmits a PSSCH to the second node after transmitting the third signaling and before transmitting the first signaling; a PSCCH scheduling the PSSCH indicates that a HARQ feedback is disabled.

In one embodiment, the first node transmits a PSSCH to the second node after transmitting the third signaling and before transmitting the first signaling; a PSCCH scheduling the PSSCH indicates that a HARQ feedback is enabled; the PSCCH is not correctly decoded by the second node.

In one embodiment, the first node does not transmit a PSSCH to the second node after transmitting the third signaling and before transmitting the first signaling.

In one embodiment, the active estimation time comprises time-domain resources lasting a first time length from an end time for transmitting third signaling.

In one subembodiment of the above embodiment, the time-domain resources comprise a slot.

In one subembodiment of the above embodiment, the time-domain resources comprise a sidelink slot.

In one subembodiment of the above embodiment, the time-domain resources comprise a subframe.

In one embodiment, the phrase of an end time for transmitting the third signaling includes: an end time of a slot occupied by the second signaling.

In one embodiment, the phrase of an end time for transmitting the third signaling includes: a start time of a first slot after a slot occupied by the third signaling.

In one embodiment, the phrase of an end time for transmitting the third signaling includes: a start time of a first slot after a slot occupied by the third signaling.

In one embodiment, the active estimation time comprises a time when a fourth timer is in a running state.

In one embodiment, the fourth timer is maintained by the second node, and the active time of the second node comprises the time when the fourth timer is in a running state.

In one embodiment, the fourth timer is started/restarted when SCI from the first node is received; herein, the SCI indicates a new transmission.

In one embodiment, the fourth timer is not started/restarted when SCI from the first node is received; herein, the SCI indicates a non-new transmission.

In one embodiment, the fourth timer is started from an end time for receiving the third signaling.

In one embodiment, the fourth timer is not started after receiving the third timer and before receiving the first signaling.

In one embodiment, an expiration value of the fourth timer is determined by the first node and the second node through negotiation.

In one embodiment, the expiration value of the fourth timer is pre-configured.

In one embodiment, the expiration value of the fourth timer is configured by a base station.

In one embodiment, the expiration value of the fourth timer is related to a Quality of Service (QoS) of traffic communicated between the first node and the second node.

In one embodiment, the first node maintains a timer corresponding to the fourth timer.

In one embodiment, the phrase of the first node maintaining a timer fully synchronized with the fourth timer includes: a timer corresponding to the fourth timer maintained by the first node has a same expiration value as the fourth timer.

In one embodiment, the phrase of the first node maintaining a timer fully synchronized with the fourth timer includes: when the second node receives a newly transmitted PSCCH from the first node, a timer corresponding to the fourth timer maintained by the first node is fully synchronized with the fourth timer; and when the second node does not receive a newly transmitted PSCCH from the first node, a timer corresponding to the fourth timer maintained by the first node is not synchronized with the fourth timer.

In one embodiment, a name of the fourth timer comprises inactivity.

In one embodiment, a name of the fourth timer comprises drx-InactivityTimer.

In one embodiment, a name of the fourth timer comprises sl-drx-InactivityTimer.

In one embodiment, the fourth timer is started/restarted when a newly transmitted PSCCH transmitted by the first node is received.

In one embodiment, the fourth timer is started/restarted in a first slot after the third signaling is received.

In one embodiment, the fourth timer is started/restarted in a start time of a first slot after the third signaling is received.

In one subembodiment of the above embodiment, the third signaling indicates that the second node is a destination receiver.

In one subembodiment of the above embodiment, the third signaling comprises at least part of the ID of the second node.

In one subembodiment of the above embodiment, the third signaling comprises lower 16 bits of the ID of the second node.

In one subembodiment of the above embodiment, the third signaling comprises at least partial bits of the ID of the first node.

In one subembodiment of the above embodiment, the third signaling comprises lower 8 bits of the ID of the first node.

In one embodiment, a timer corresponding to the fourth timer maintained by the first node is started from a first slot after the third signaling is transmitted.

In one embodiment, a timer corresponding to the fourth timer maintained by the first node is not re-started after a start of a first slot after the third signaling is transmitted and before the first signaling is transmitted.

In one embodiment, the first time length is not greater than the expiration value of the fourth timer.

In one embodiment, the first time length is the expiration value of the fourth timer.

In one embodiment, the first time length comprises a duration from a start/restart of the fourth timer to an end time for receiving a first MAC CE; herein, the end time for receiving the first MAC CE is earlier than a time of a current expiration of the fourth timer.

In one embodiment, the first time length comprises a duration from an end time for transmitting the third signaling to an end time for transmitting a first MAC CE; herein, a timer corresponding to the fourth timer maintained by the first node is started in a slot immediately after the third signaling is transmitted; an end time for transmitting the first MAC CE is earlier than a time of a current expiration of the timer corresponding to the fourth timer maintained by the first node.

In one embodiment, a first MAC CE is used to stop the fourth timer.

In one embodiment, the third signaling indicates a new transmission.

In one embodiment, the new transmission is a first transmission of a Transport Block (TB).

In one embodiment, the new transmission is a transmission other than a TB retransmission.

In one embodiment, the new transmission is a first transmission for a TB repetition.

In one embodiment, the new transmission is a last transmission for a TB repetition.

In one embodiment, when the new transmission is executed, a New Data Indication (NDI) is reversed.

In one embodiment, the third signaling and the first signaling belong to a same type of signalings.

In one embodiment, the third signaling is a PSCCH.

In one embodiment, the second radio signal and the first radio signal belong to a same type of radio signals.

In one embodiment, the second radio signal is a PSSCH.

In one embodiment, the third signaling and the second radio signal comprises the ID of the second node.

In one embodiment, a receiver of the second radio signal is the second node.

In one embodiment, the third signaling and time-frequency resources occupied by the second radio signal are reserved for a sidelink transmission.

In one embodiment, a slot where a start time of the third signaling is located is the same as a slot where a start time of the second radio signal is located.

In one embodiment, time-frequency resources occupied by the fourth signaling and time-frequency resources occupied by the third signaling belong to a same resource pool.

In one embodiment, the third signaling comprises configuration information of the second radio signal.

In one embodiment, the configuration information of the second radio signal comprises information required to decode the second bit block.

In one embodiment, all or part of the second bit block is used to generate the second radio signal.

In one embodiment, all or part of the second bit block and a reference signal are used together to generate the second radio signal.

In one embodiment, the second radio signal is acquired after all or partial bits in a second bit block sequentially through CRC Calculation, Channel Coding, Rate matching, Scrambling, Modulation, Layer Mapping, Antenna Port Mapping, Mapping to Virtual Resource Blocks, Mapping from Virtual to Physical Resource Blocks, OFDM Baseband Signal Generation, Modulation and Upconversion.

In one embodiment, when the second signaling is not received and the time for transmitting the first signaling does not belong to the active estimation time, a continuation of transmitting a radio signal to the second node is dropped after the first radio signal is transmitted.

In one embodiment, the phrase of not belonging to the active estimation time includes: a time when the first timer is not in a running state, the second timer is not in a running state, and the fourth timer is not in a running state.

In one embodiment, the phrase of not belonging to the active estimation time includes: a time when the first timer is not in a running state, the second timer is not in a running state, and after time-domain resources lasting the first time length from an end time for receiving the third signaling.

In one embodiment, the phrase of not belonging to the active estimation time includes: a time when the timer fully synchronized with the first timer maintained by the first node is not in a running state, the timer fully synchronized with the second timer maintained by the first node is not in a running state, and the timer corresponding to the fourth timer maintained by the first node is not in a running state.

In one embodiment, the phrase of not belonging to the active estimation time includes: a timer when the timer fully synchronized with the first timer maintained by the first node, the timer fully synchronized with the second timer maintained by the first node is not in a running state, and after time-domain resources lasting the first time length from an end time for transmitting the third signaling

In one embodiment, the phrase of dropping a continuation of transmitting a radio signal to the second node after transmitting the first radio signal includes: the first node stops transmitting a radio signal to the second node when it is not in the active estimation time.

In one embodiment, the phrase of dropping a continuation of transmitting a radio signal to the second node after transmitting the first radio signal includes: the first node stops transmitting a radio signal to the second node before the timer fully synchronized with the first timer is started/restarted.

In one embodiment, the phrase of dropping a continuation of transmitting a radio signal to the second node after transmitting the first radio signal includes: the first node transmits a radio signal to a node other than the second node.

In one embodiment, the phrase of dropping a continuation of transmitting a radio signal to the second node after transmitting the first radio signal includes: the first node is in a receiving state.

In one embodiment, the second node has at least two communication correspondences, and the first node is one of the at least two communication correspondences; the at least two communication correspondences are not quasi co-located.

In one subembodiment of the above embodiment, when the at least two communication correspondences other than a communication correspondence of the first node is(are) in communications with the second node, the second node is in an active time and can receive a PSCCH and a PSSCH of the first node.

In one embodiment, the first signaling is transmitted in a time not belonging to the active estimation time, and when the second node receives the first signaling, the fourth timer can be started/restarted and data transmitted by the first node can continue to be received.

In one subembodiment of the above embodiment, the first signaling is transmitted for the second node with the at least two communication correspondences in a time not belonging to the active estimation time, which can implement a transmission for emergency traffic for the first node.

In one embodiment, the second node is configured with DRX.

In one embodiment, the DRX parameters are configured by the network.

In one embodiment, the DRX parameters are configured by SIB.

In one embodiment, the first node transmits first information.

In one embodiment, the first information comprises higher-layer information.

In one embodiment, the first information comprises a PC5-RRC signaling.

In one embodiment, the first information comprises the DRX parameter.

In one embodiment, the second information is received before the first information is transmitted.

In one embodiment, the second information comprises higher-layer information.

In one embodiment, the second information comprises a PC5-S signaling.

In one embodiment, the second information comprises a PC5-RRC signaling.

In one embodiment, the second information comprises auxiliary information for configuring the DRX parameters.

In one embodiment, the first information is comprised in all or partial IEs in an RRC signaling.

In one embodiment, the first information is comprised in all or partial fields in an IE in an RRC signaling.

In one embodiment, the first information comprises the expiration value comprising the first timer.

In one embodiment, the first information indicates a time when the first timer is started/restarted.

In one embodiment, the PC5-RRC signaling comprises an RRCReconfigurationSidelink.

In one embodiment, when the DRX parameters are configured or pre-configured by a base station, the behavior of transmitting the first information is not executed.

### Embodiment 6

Embodiment 6 illustrates a schematic diagram of a second signaling according to one embodiment of the present disclosure, as shown in FIG. 6. In FIG. 6, the slash-filled rectangle represents a first signaling and a first signal, and the thick line-framed rectangle on the left represents a first time-frequency resource set; the cross line-filled sub-rectangle represents a second signaling, and the thick line-framed rectangle on the right represents a first resource sub-pool.

In one embodiment, a PSFCH corresponding to a PSSCH transmitted in a first time-frequency resource set is in a first resource sub-pool.

In one embodiment, configuration information of the first resource pool comprises configuration information of PSFCH.

In one embodiment, a name of the configuration information of the PSFCH comprises SL-P SFCH-Config.

In one embodiment, a name of the configuration information of the PSFCH is SL-P SFCH-Config-r16.

In one embodiment, the configuration information of the first resource pool is higher-layer information.

In one embodiment, the configuration information of the first resource pool is RRC information.

In one embodiment, the configuration information of the first resource pool is acquired through a base station.

In one embodiment, the configuration information of the first resource pool is preset.

In one embodiment, a name of the configuration information of the first resource pool comprises an SL-ResourcePool.

In one embodiment, the configuration information of the first resource pool is an IE in an SIB12 message.

In one embodiment, the configuration information of the first resource pool is an IE in an SL-ConfigDedicatedNR message.

In one embodiment, the configuration information of the first resource pool is an IE in a SidelinkPreconfigNR message.

In one embodiment, the configuration information of the first resource pool comprises a number of sub-channel(s) comprised in the first resource pool.

In one embodiment, a sub-channel comprises at least one Physical Resource Block (PRB) in frequency domain.

In one embodiment, a PRB comprises 12 subcarriers in frequency domain.

In one embodiment, the first resource pool comprises L PRB(s), each sub-channel comprises N PRB(s), a number of the sub-channel(s) comprised in the first resource pool is

$$⌊ \frac{L}{N} ⌋ ,$$

herein, └·┘ is operation of rounding down to an integer, and N and L are respectively positive integers.

In one embodiment, the configuration information of the first resource pool comprises at least one of a PSFCH resource cycle, PSFCH frequency-domain resources, a number of PSFCH Cyclic Shift pair(s), a minimum time interval of a PSFCH or a PSFCH resource type; herein, the PSFCH resource cycle indicates frequency that PSFCH resources occur in the first resource pool, and when the PSFCH resource cycle is 1, it indicates the PSFCH resources are comprised in each slot; the PSFCH frequency-domain resources indicate a number of PRB(s) occupied by a PSFCH; a number of the PSFCH cyclic shift pair(s) indicates a maximum number of cyclic shift pair(s) that can be multiplexed on one PRB; the PSFCH minimum time interval indicates a minimum time interval from receiving a PSFCH to transmitting a PSFCH; the PSFCH resource type indicates a type of frequency-domain resources occupied by a PSFCH.

In one embodiment, a time interval between a slot where the second signaling is located and a slot where the first radio signal is located is not less than the PSFCH minimum time interval.

In one embodiment, the second signaling is monitored in a first slot comprising PSFCH resources after a last slot for transmitting the first radio signal passes the PSFCH minimum time interval.

In one embodiment, a slot comprising PSFCH resources occurs periodically in the first resource pool, and the PSFCH resource period can be 1, 2 or 4 slots.

In one embodiment, time-frequency resources occupied by the first radio signal in the first resource pool are used to determine frequency-domain resources occupied by the second signaling.

In one embodiment, an index of the first radio signal in the first time-frequency resource set and an index of a starting sub-channel occupied by the first radio signal in the first resource pool are used to determine the frequency-domain resources occupied by the second signaling.

In one embodiment, the index of the first radio signal in the first time-frequency resource set and an index of a sub-channel occupied by the first radio signal in the first resource pool are used to determine frequency-domain resources occupied by the second signaling.

In one embodiment, a value range of the index of the first time-frequency resource set is 0, 1, . . . Q; herein, a value of Q is a value of the PSFCH resource period.

In one embodiment, [(i+j·N_{PSSCH}^{PSFCH})·M_{subch,slot}^{PSFCH}, (i+1+j·N_{PSSCH}^{PSFCH})·M_{subch,slot}^{PSFCH}−1] PRB(s) is(are) allocated to a PSSCH transmitted in a slot i and a sub-channel j of the first resource pool in an ascending order first according to slot and then according to frequency domain as frequency-domain resources of a PSFCH corresponding to the PSSCH, herein, 0≤i≤N_{PSSCH}^{PSFCH}, 0≤j≤N_{subch}, the N_{PSSCH}^{PSFCH} is the PSFCH resource period configured in the first resource pool, the M_{subch,slot}^{PSFCH}=M_{PRB, set}^{PSFCH}/(N_{subch}·N_{PSSCH}^{PSFCH}), the M_{PRB,set}^{PSFCH} is a number of PRB(s) comprised in the PSFCH frequency-domain resources configured by the first resource pool; and the N_{subch} is a number of sub-channel(s) comprised in the first resource pool.

In one embodiment, the index of a starting sub-channel occupied by the first radio signal is used to determine a number of PRB(s) comprised in a first PSFCH resource set.

In one embodiment, the index of a starting sub-channel occupied by the first radio signal and a number of sub-channel(s) occupied by the first radio signal are used together to determine the number of PRB(s) comprised in the first PSFCH resource set.

In one embodiment, the first PSFCH resource set comprises the first PSFCH resource.

In one embodiment, a first PSFCH resource set comprises R_{PRB,CS}^{PSFCH}=N_{type}^{PSFCH}·M_{subch,slot}^{PSFCH}·N_{CS}^{PSFCH} PSFCH resource(s); herein, when an index of a starting sub-channel occupied by the first radio signal is used to determine the first PSFCH resource set, the N_{type}^{PSFCH} is 1; when an index of a sub-channel occupied by the first radio signal is used to determine the first PSFCH resource set, the N_{type}^{PSFCH}=N_{subch}^{PSSCH}, where N_{subch}^{PSSCH} is a number of sub-channel(s) occupied by the first radio signal; the N_{CS}^{PSFCH} indicates a number of the PSFCH cyclic shift pair(s); the PSFCH resource(s) is(are) sorted in an ascending order first according to PRB and then according to cyclic shift pair.

In one embodiment, at least a former of the source ID comprised in the first signaling and a higher-layer ID of the second node is used to determine an index of the first PSFCH resource in the first PSFCH resource set.

In one embodiment, an index of the first PSFCH resource in the first PSFCH resource set is P_{ID}mod R_{PRB,CS}^{PSFCH}, herein, the P_{ID} is the source ID comprised in the first signaling.

In one embodiment, when a value of a cast type field comprised in the SCI format 2-A comprised in the first signaling is 01, an index of the first PSFCH in the first PSFCH resource set is (P_{ID}+M_{ID})mod R_{PRB,CS}^{PSFCH}, herein, the P_{ID} is the source ID comprised in the first signaling, and the M_{ID} is the higher-layer ID of the second node.

In one embodiment, the higher-layer ID of the second node indicates an ID of the second node in a groupcast group.

In one embodiment, the first PSFCH resource is determined according to the method described in section 16.3 of protocol 38.213 of 3GPP.

In one embodiment, the source ID comprised in the first signaling is a physical-layer ID.

In one embodiment, an information bit of a HARQ-ACK is mapped to a pair of cyclic shifts multiplexed in PRB.

In one embodiment, an information value NACK of the HARQ-ACK is mapped to a sequence cyclic shift 0; an information value ACK of the HARQ-ACK is mapped to the sequence cyclic shift 6, where an information value of the HARQ-ACK comprises an ACK or a NACK.

In one embodiment, an information value NACK of the HARQ-ACK is mapped to the sequence cyclic shift 0, herein, an information value of the HARQ-ACK only comprises a NACK.

In embodiment 6, frequency-domain resources of the first resource pool comprise four sub-channels, namely sub-channel 0, sub-channel 1, sub-channel 2 and sub-channel 3; each sub-channel respectively comprises 4 PRBs; the source ID comprised in the first signaling is 20, and the higher-layer ID of the second node is 0; the PSFCH resource period of the first resource pool is 4, the PSFCH frequency-domain resources configured by the first resource pool comprise 16 PRBs, and the PSFCH minimum time interval configured by the first resource pool is 1; PSFCH resources corresponding to a PSSCH on 4 slots comprised in a first time-frequency resource set belong to a first resource sub-pool; a number of the PSFCH cyclic shift pair(s) configured by the first resource pool is 1; the PSFCH resource type configured by the first resource pool is 1; it is determined that PSFCH feedback resources corresponding to each PSSCH comprises one PRB according to the PSFCH configuration parameters; the index of a slot occupied by the first radio signal in the first time-frequency resource set is 1, and an index of a starting position of a sub-channel occupied by the first radio signal is 1, an index of a slot of the first radio signal in the first time-frequency resource set and the index of a starting sub-channel of the first radio signal in the first time-frequency resource set are used to determine that the first PSFCH resource set comprises a PRB indexed as 5 in the first resource sub-pool; the source ID comprised in the first signaling and the higher-layer ID of the second node are used to determine that an index of the first PSFCH resource occupied by the second signaling in the first PSFCH resource set is 0, that is, the second signaling occupies a PRB indexed as 5 in the first resource sub-pool; a number of the cyclic shift pair(s) configured by the first resource pool is 1, that is, 1 pair of cyclic shifts is multiplexed on each PRB comprised in the first PSFCH resource set; the cyclic shift is determined according to a reception result of the first radio signal.

### Embodiment 7

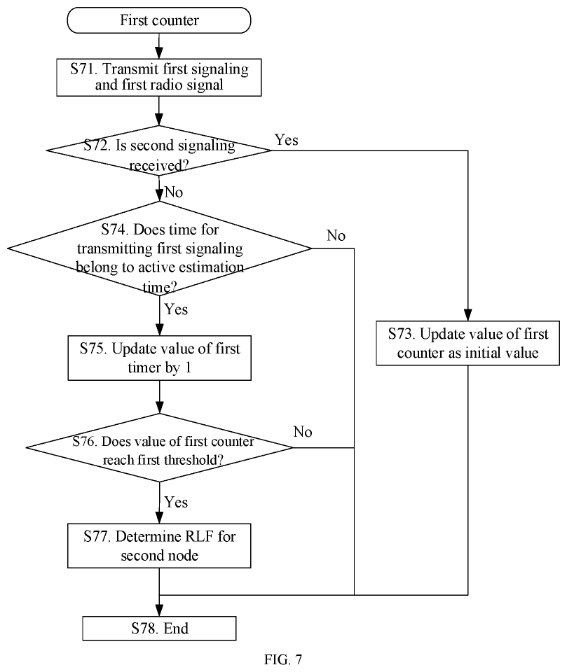

Embodiment 7 illustrates a schematic diagram of running of a first counter according to one embodiment of the present disclosure, as shown in FIG. 7. Steps in FIG. 7 are executed in a first node.

Transmit a first signaling and a first radio signal in step S71; in step S72, judge whether a second signaling is received, if yes, execute step S73, if no, execute step S74; end after updating a value of a first counter to an initial value in step S73; in step S74, judge whether a transmission time of a first signaling belongs to an active estimation time, if yes, execute step S75, if no, skip to step S78 to end; update a value of a first counter by 1 in step S75; in step S76, judge whether a value of a first counter reaches a first threshold, if yes, execute step S77, if no, skip to step S78 to end; determine an RLF for a second node in step S77.

In one embodiment, when the second signaling is not received and the time for transmitting the first signaling does not belong to the active estimation time, the first counter is not updated.

In one embodiment, judging whether a second signaling is received includes: the first node receives one of an ACK or a NACK on the first PSFCH resource, indicating that the second signaling is received; the first node does not receive any of an ACK feedback or a NACK feedback on the first PSFCH resource, indicating that the second signaling is not received.

In one embodiment, when the value of the first counter reaches the first threshold, and as a response to the value of the first timer reaching the first threshold, an RLF for the second node is triggered.

### Embodiment 8

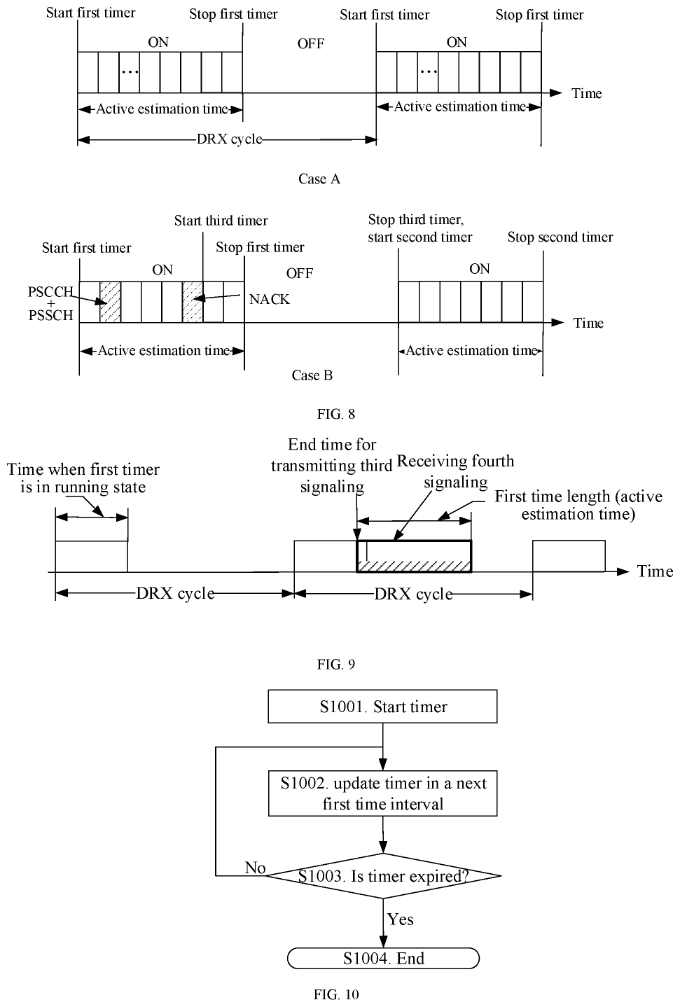

Embodiment 8 illustrates a schematic diagram of an active estimation time according to one embodiment of the present disclosure, as shown in FIG. 8. In FIG. 8, a rectangle represents a slot, a slot corresponding to ON belongs to an active estimation time, and a slot corresponding to OFF does not belong to an active estimation time, and the slash-filled rectangle comprises a PSCCH and a PSSCH; the cross line-filled rectangle comprises a PSFCH.

In one embodiment, the active estimation time is a time when the first timer is in a running state; the first timer is a sl-drx-onDurationTimer.

In one embodiment, the active estimation time is a time when the second timer is in a running state; the second timer is a sl-drx-RetransmissionTimer.

In case A of embodiment 8, the active estimation time is the time when the first timer is in a running state, the first timer starts running in each DRX cycle, and the time when the first timer is in a running state is periodic.

In case B in embodiment 8, when SCI from the first node received by the second node indicates that a HARQ feedback is enabled, and a PSSCH scheduled by the SCI is not correctly decoded, the third timer is started/restarted at a start time of a slot immediately after transmitting a NACK corresponding to the PSSCH scheduled by the SCI to the first node; the second timer is started when the third timer expires and stops running; the active estimation time comprises the time when the second timer is in a running state.

### Embodiment 9

Embodiment 9 illustrates a schematic diagram of another active estimation time according to one embodiment of the present disclosure, as shown in FIG. 9. In FIG. 9, the unfilled rectangle represents a time when a first timer is a running state, and the thick line-framed slash-filled rectangle represents an active estimation time.

In one embodiment, the active estimation time comprises a time lasting the first time length from an end time for transmitting third signaling.

In one embodiment, at least one of the first timer or the second timer is in a running state when the third signaling is transmitted.

In one embodiment, at least one of a timer fully synchronized with the first timer maintained by the first node or a timer fully synchronized with the second timer maintained by the first node is in a running state when the third signaling is transmitted.

In one embodiment, any of the first timer, the second timer or the fourth timer is not in a running state when the third signaling is transmitted.

In one embodiment, an end time lasting the first time length from an end time for transmitting the third signaling is an end time of the fourth timer; herein, a PSCCH of a new transmission from the first node is not received after the third signaling is received and before the first signaling is received.

In one embodiment, an end time lasting for the first time length from an end time for transmitting the third signaling is an end time for transmitting a first MAC CE; herein, a timer corresponding to the fourth timer maintained by the first node is started/restarted in a slot immediately after the third signaling is transmitted; an end time for transmitting the first MAC CE is earlier than a time of a current expiration of the timer corresponding to the fourth timer maintained by the first node.

### Embodiment 10

Embodiment 10 illustrates a schematic diagram of running of a timer according to one embodiment of the present disclosure, as shown in FIG. 10.

Start a timer in step S1001; in step S1002, update a timer in a next first time interval; in step S1003, judge whether a timer is expired, is yes, end, if no, skip to the step S1002.

In one embodiment, the timer is the first timer.

In one embodiment, the timer is the second timer.

In one embodiment, the timer is the third timer.

In one embodiment, the timer is the fourth timer.

In one embodiment, the timer is a timer fully synchronized with the first timer maintained by the first node.

In one embodiment, the timer is a timer fully synchronized with the second timer maintained by the first node.

In one embodiment, the timer is a timer fully synchronized with the third timer maintained by the first node.

In one embodiment, the timer is a timer corresponding to the fourth timer maintained by the first node.

In one embodiment, for the second node, when the timer is running, the second node is in an active time; and when the timer stops running, the second node is not in an active time.

In one embodiment, when the timer is running, the timer is updated at each the first time interval.

In one embodiment, when the timer is not in a running state, the timer is stopped to be updated at each the first time interval.

In one embodiment, the first time interval is 1 millisecond.

In one embodiment, the first time interval is a subframe.

In one embodiment, the first time interval is a slot.

In one embodiment, the expiration value of the timer uses a same unit for measurement as the first time interval.

In one embodiment, a value of the timer is set as 0 when the timer is started, and the phrase of updating a timer includes: a value of the timer is increased by 1; when a value of the timer is the expiration value of the timer, the timer is expired.

In one embodiment, a value of the timer is set as the expiration value of the timer when the timer is started, and the phrase of updating the timer includes: a value of the timer is decreased by 1; when a value of the timer is 0, the timer is expired.

In one embodiment, the timer stops timing after being expired.

In one embodiment, when the first time interval is 1 ms, the next first time interval is an upcoming ms.

In one embodiment, when the first time interval is 1 subframe, the next first time interval is an upcoming subframe.

In one embodiment, when the first time interval is a slot, the next first time interval is an upcoming slot.

### Embodiment 11

Embodiment 11 illustrates a schematic diagram of a sidelink slot according to one embodiment of the present disclosure, as shown in FIG. 11. In FIG. 11, the slash-filled box represents a slot reserved for sidelink, and the unfilled box represents a slot reserved for Downlink (DL)/Uplink (UL).

In one embodiment, slots reserved for sidelink are continuous in time domain.

In one embodiment, slots reserved for sidelink are discontinuous in time domain.

In one embodiment, when slots reserved for sidelink are discontinuous in time domain, and the slots reserved for sidelink consist time-domain resources of the first resource pool; the time-domain resources of the first resource pool are continuous in logical time.

In one embodiment, the phrase of being continuous in logical time includes: being continuous in subframe.

In one embodiment, the phrase of being continuous in logical time includes: being continuous in slot index.

In case A in embodiment 11, slots reserved for sidelink are continuous in time domain.

In case B of embodiment 11, slots reserved for sidelink are discontinuous in time domain and continuous in logical time.

In one embodiment, an end time for transmitting and an end time for receiving in the present disclosure are defined for time in the first resource pool.

In one embodiment, the phrase of an end time for transmitting includes: an end time for transmitting a symbol/slot.

In one embodiment, the phrase of an end time for transmitting includes: a start time of a first symbol/slot after transmitting a symbol/slot.

In one embodiment, the phrase of an end time for transmitting includes: a start time of a slot immediately following an end time for transmitting a symbol/slot.

In one embodiment, the phrase of an end time for receiving includes: an end time for receiving a symbol/slot.

In one embodiment, the phrase of an end time for receiving includes: a start time of a first symbol/slot after receiving a symbol/slot.

In one embodiment, the phrase of an end time for receiving includes: a start time of a slot immediately following an end time for receiving a symbol/slot.

### Embodiment 12

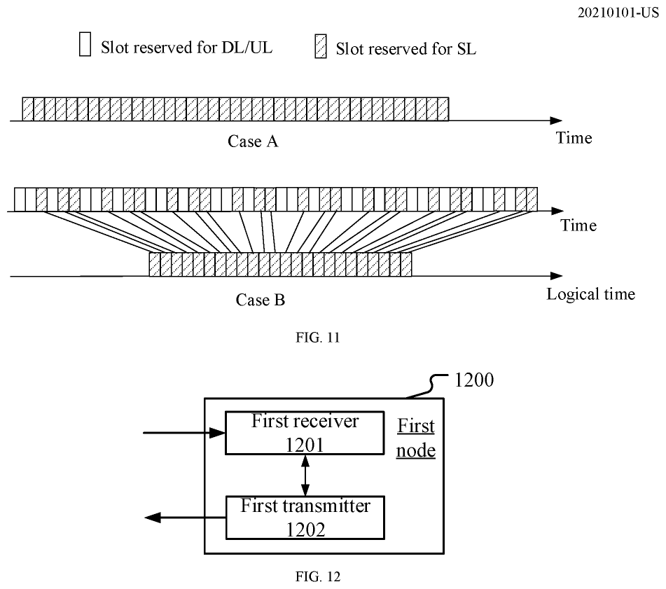

Embodiment 12 illustrates a structure block diagram of a processing device in a first node according to one embodiment of the present disclosure, as shown in FIG. 12. In FIG. 12, a processing device 1200 in a first node comprises a first receiver 1201 and a first transmitter 1202. The first receiver 1201 comprises at least one of the transmitter/receiver 454 (including the antenna 452), the receiving processor 456, the multi-antenna receiving processor 458 or the controller/processor 459 in FIG. 4 of the present disclosure; the first transmitter 1202 comprises at least one of the transmitter/receiver 454 (including the antenna 452), the transmitting processor 468, the multi-antenna transmitting processor 457, or the controller/processor 459 in FIG. 4 of the present disclosure.

In embodiment 12, the first transmitter 1202 transmits a first signaling and a first radio signal; the first receiver 1201 monitors a second signaling; maintains a first counter according to whether the second signaling is received; and as a response to a value of the first counter reaching a first threshold, determines an RLF for a second node; wherein the first signaling comprises configuration information of the first radio signal; the second signaling is used to indicate whether the first radio signal is correctly decoded; the behavior of maintaining a first counter according to whether the second signaling is received comprises: when the second signaling is received, updating the value of the first counter to an initial value; when the second signaling is not received and a time for transmitting the first signaling belongs to an active estimation time, updating the value of the first counter by 1; when the second signaling is not received and the time for transmitting the first signaling does not belong to the active estimation time, keeping the value of the first counter unchanged; the active estimated time comprises a time when a first timer is in a running state.

In one embodiment, the active estimation time comprises a time when a second timer is in a running state.

In one embodiment, the first transmitter 1202 transmits a third signaling and a second radio signal; the receiver 1201 receives a fourth signaling; wherein the fourth signaling is used to indicate whether the second radio signal is correctly decoded, the fourth signaling comprises a last received HARQ-ACK from the second node, and the active estimation time comprises time-domain resources lasting a first time length from an end time for transmitting the third signaling.

In one embodiment, the first transmitter 1201, when the second signaling is not received and the time for transmitting the first signaling does not belong to the active estimation time, drops a continuation of transmitting a radio signal to the second node after transmitting the first radio signal; herein, the second node has at least two communication correspondences, and the first node is one of the at least two communication correspondences; the at least two communication correspondences are not quasi co-located.

In one embodiment, the second node is configured with DRX.

In one embodiment, the first transmitter 1202 transmits first information; herein, the first information comprises an expiration value of the first timer.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first-type communication node or a UE or a terminal in the present disclosure includes but not limited to mobile phones, tablet computers, laptops, network cards, low-power devices, enhanced Machine Type Communication (eMTC) devices, NB-IOT devices, vehicle-mounted communication equipment, aircrafts, airplanes, unmanned aerial vehicles (UAVs), tele-controlled aircrafts and other wireless communication devices. The second-type communication node or the base station or the network side device in the present disclosure includes but is not limited to the macro-cellular base stations, micro-cellular base stations, home base stations, relay base stations, eNB, gNB, Transmission and Reception Points (TRPs), relay satellites, satellite base stations, air base stations and other wireless communication equipment.

The above are merely the preferred embodiments of the present disclosure and are not intended to limit the scope of protection of the present disclosure. Any modification, equivalent substitute and improvement made within the spirit and principle of the present disclosure are intended to be included within the scope of protection of the present disclosure.

What is claimed is:

1. A first node for wireless communications, comprising:
a first transmitter, transmitting a first signaling and a first radio signal; and
a first receiver, monitoring a second signaling; maintaining a first counter according to whether the second signaling is received; and as a response to a value of the first counter reaching a first threshold, determining an RLF for a second node;
wherein the first signaling comprises configuration information of the first radio signal; the second signaling is used to indicate whether the first radio signal is correctly decoded; the behavior of maintaining a first counter according to whether the second signaling is received comprises: when the second signaling is received, updating the value of the first counter to an initial value; when the second signaling is not received and a time for transmitting the first signaling belongs to an active estimation time, updating the value of the first counter by 1; when the second signaling is not received and the time for transmitting the first signaling does not belong to the active estimation time, keeping the value of the first counter unchanged; the active estimated time comprises a time when a first timer is in a running state.

2. The first node according to claim 1, wherein the active estimation time comprises a time when a second timer is in a running state.

3. The first node according to claim 1, comprising:
the first transmitter, transmitting a third signaling and a second radio signal; and
the first receiver, receiving a fourth signaling;
wherein the fourth signaling is used to indicate whether the second radio signal is correctly decoded, the fourth signaling comprises a last received HARQ-ACK from the second node, and the active estimation time comprises time-domain resources lasting a first time length from an end time for transmitting the third signaling.

4. The first node according to claim 1, comprising:
the first transmitter, when the second signaling is not received and the time for transmitting the first signaling does not belong to the active estimation time, dropping a continuation of transmitting a radio signal to the second node after transmitting the first radio signal;
wherein the second node has at least two communication correspondences, and the first node is one of the at least two communication correspondences; the at least two communication correspondences are not quasi co-located.

5. The first node according to claim 1, wherein the second node is configured with a discontinuous reception (DRX).

6. The first node according to claim 1, comprising:
the first transmitter, transmitting first information;
wherein the first information comprises an expiration value of the first timer.

7. The first node according to claim 1, wherein the first timer is maintained by the second node, and an active time of the second node comprises the time when the first timer is in a running state.

8. The first node according to claim 1, wherein the first node maintains a timer fully synchronized with the first timer.

9. The first node according to claim 2, wherein the second timer is maintained by the second node, and an active time of the second node comprises the time when the second timer is in a running state.

10. The first node according to claim 2, wherein the first node maintains a timer fully synchronized with the second timer.

11. The first node according to claim 1, wherein when the second signaling is not received and the time for transmitting the first signaling belongs to the active estimation time, an occurrence of a HARQ-DTX is determined.

12. A method in a first node for wireless communications, comprising:
transmitting a first signaling and a first radio signal;
monitoring a second signaling;
maintaining a first counter according to whether the second signaling is received; and
as a response to a value of the first counter reaching a first threshold, determining an RLF for a second node;
wherein the first signaling comprises configuration information of the first radio signal; the second signaling is used to indicate whether the first radio signal is correctly decoded; the behavior of maintaining a first counter according to whether the second signaling is received comprises: when the second signaling is received, updating the value of the first counter to an initial value; when the second signaling is not received and a time for transmitting the first signaling belongs to an active estimation time, updating the value of the first counter by 1; when the second signaling is not received and the time for transmitting the first signaling does not belong to the active estimation time, keeping the value of the first counter unchanged; the active estimated time comprises a time when a first timer is in a running state.

13. The method in a first node according to claim 12, wherein the active estimation time comprises a time when a second timer is in a running state.

14. The first node according to claim 12, comprising:
transmitting a third signaling and a second radio signal; and
receiving a fourth signaling;
wherein the fourth signaling is used to indicate whether the second radio signal is correctly decoded, the fourth signaling comprises a last received HARQ-ACK from the second node, and the active estimation time comprises time-domain resources lasting a first time length from an end time for transmitting the third signaling.

15. The method in a first node according to claim 12, comprising:
when the second signaling is not received and the time for transmitting the first signaling does not belong to the active estimation time, dropping a continuation of transmitting a radio signal to the second node after transmitting the first radio signal;
wherein the second node has at least two communication correspondences, and the first node is one of the at least two communication correspondences; the at least two communication correspondences are not quasi co-located.

16. The method in a first node according to claim 12, wherein the second node is configured with a DRX.

17. The method in a first node according to claim 12, wherein the first timer is maintained by the second node, and an active time of the second node comprises the time when the first timer is in a running state.

18. The method in a first node according to claim 12, wherein the first node maintains a timer fully synchronized with the first timer.

19. The method in a first node according to claim 13, wherein the second timer is maintained by the second node, and an active time of the second node comprises the time when the second timer is in a running state.

20. The method in a first node according to claim 13, wherein the first node maintains a timer fully synchronized with the second timer.
